(19) United States
(12) Patent Application Publication
(10) Pub. No.: US 2008/0157426 A1
(43) Pub. Date: Jul. 3, 2008

(54) Process and apparatus for reducing die drips and for controlling surface roughness during polymer extrusion

(76) Inventors: Joseph E. Kotwis, Clinton, IA (US); Donald L. Rymer, Little Hocking, OH (US); Christopher J. Nesbitt, Cincinnati, OH (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/811,248

(22) Filed: Jun. 7, 2007

Related U.S. Application Data
(60) Provisional application No. 60/877,742, filed on Dec. 29, 2006.

(51) Int. Cl. B29C 47/88

(52) U.S. Cl. 264/211.12; 425/445

(57) ABSTRACT

Provided is a method of reducing the incidence of defects caused by die drool or die drips on extruded polymeric products such as films and sheets. The method includes the step of directing a flow of gas towards the die. The flow of gas is substantially parallel to one or more surfaces of the extrudate, and the temperature of the gas is about 50° C. to about 300° C. when it impinges on the surface of the die. Moreover, selecting the temperature or flow rate of the gas provides a method of determining the surface roughness of the extruded polymer.

### CROSS-REFERENCES TO RELATED APPLICATIONS

The present application claims priority under 35 U.S.C. §120 to U.S. Provisional Appln. No. 60/877,742, filed on Dec. 29, 2006, which is incorporated by reference herein in its entirety.

### BACKGROUND OF THE INVENTION

1. Field of the Invention

The invention relates to the field of polymer extrusion, and, more specifically, to the art of reducing the defects in extruded products that are caused by material dripping from the extrusion die onto the polymer extrudate and to the art of controlling the surface roughness of the extrudate.

2. Description of the Related Art

Several patents and publications are cited in this description in order to more fully describe the state of the art to which this invention pertains. The entire disclosure of each of these patents and publications is incorporated by reference herein.

In a polymer extrusion process, a “die drip” is an unwanted deposit on the horizontal, external land of the extrusion die. In general, die drips initially form at the intersection of the polymer melt, the die lips, and the atmosphere. The deposit increases in area as its mass increases. Eventually, if the mass of the deposit is not decreased, for example by scraping the exterior of the die, the deposit elongates into downward extending droplets whose tails adhere to the die lip. These droplets will cause surface defects on the extrudate, if they adhere to it before or after they detach from the die lips. Other defects that may be caused by these deposits and droplets include rubbing against the sheet to produce a die line and leaving a residue of burnt resin on the surface of the extrudate.

Thus, die drips cause at least two forms of inefficiency in polymer extrusion processes. First, in many applications, surface defects on the extruded product are unacceptable. The extrusion of polymeric sheets to be used as interlayers in safety glass is one example of such a process. Thus, an extruded product that is contaminated by die drips must be recycled or discarded as scrap. Second, the capacity of an extrusion facility is reduced when production must be stopped so that the extrusion equipment may be cleaned of unwanted deposits that may result in die drips.

The problem of die dripping or “die drool” is endemic to polymeric extrusion processes. Some methods to reduce or eliminate die drips are set forth in U.S. Pat. No. 3,502,757, issued to Spencer, which describes small quantities of clean gas that are directed against one or both sides of an extruded sheet, and in U.S. Pat. No. 6,358,449, issued to Tinsley et al., which describes a heated gaseous fluid that is provided proximate the molten polymer exit so as to maintain the die temperature at the molten polymer exit as low as possible without affecting the processability or integrity of the product film.

In most applications, then, it is important for the extrudate to have a smooth surface, free of the defects caused by die drips. Often, however, some level of surface roughness is useful in extruded polymeric products. For example, in films or sheets that are destined for use as interlayers in safety glass, a degree of surface roughness facilitates the removal of air from the laminated structure. Interstitial air, for example a bubble entrained between two layers, may result in an unacceptable visible defect in a safety glass laminate. As noted above, however, even roughened extrudates having surface defects caused by die drips are unacceptable for use as safety glass interlayers.

In some processes, this surface roughness is obtained by extruding the polymer under melt fracture conditions. “Melt fracture” refers to the spontaneous formation of a textured surface pattern on the polymeric extrudate. In an extrusion under melt fracture conditions, the temperature and pressure of the polymer at the die exit and other process variables must be carefully regulated. See, for example, the description of a melt fracture extrusion process in U.S. Pat. No. 5,151,234, issued to Ishihara et al.

It is also known in the art to impart surface roughness to a polymeric extrudate by embossing its surface, for example by casting the molten extrudate onto a patterned embossing roller, or by later applying pressure, with or without heat, to impart a pattern to the extruded product. When a polymer is embossed, considerably more flexibility is available in the extrusion process conditions than is available in an extrusion process in which the desired level of surface roughness is attained by running under melt fracture conditions. This flexibility, however, comes at the price of an increased investment in machinery and an additional processing step.

Accordingly, there exists a need for a method of reducing the incidence of defects caused by die drips on extruded polymeric products such as films and sheets, whether they are extruded under conventional conditions, in which smoothness or clarity are maximized, or under melt fracture conditions. There also exists a need to improve the ability to control the level of surface roughness that is imparted by extrusion processes, again whether the processes are conducted under melt fracture conditions or under conventional conditions.

### SUMMARY OF THE INVENTION

Described herein is a method of reducing the incidence of defects caused by die drips on extruded polymeric products such as films and sheets, for example. In one embodiment of the method, the extrusion process is run under melt fracture conditions. The method includes the step of directing a flow of gas towards the extrusion die. The flow of gas is substantially parallel to one or more surfaces of the extrudate, and the temperature of the gas is from about 50° C. to about 300° C. when it impinges on the die.

Also described is a method of attaining a targeted surface roughness in an extruded polymer. In this method, a polymeric product is extruded. Again, a flow of gas is directed towards the die, and the flow of gas is substantially parallel to one or more surfaces of the extrudate. The temperature of the gas is selected to attain the targeted surface roughness, which may be zero.

Also described is an apparatus for reducing the incidence of die drips in a polymer extrusion process. The apparatus comprises a gas flow manifold that is reversibly connected to a support structure. The gas flow manifold is removably and repeatably positionable in an air gap of a polymer extrusion apparatus.

One or more of the above and various other advantages and features of novelty that characterize the invention are pointed out with particularity in the claims annexed hereto and forming a part hereof. For a better understanding of the invention, its advantages, and the objects obtained by its use, however, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a cross-sectional view of an extrusion die and quenching bath during the extrusion of a polymeric product.

FIG. 2 is a cross-sectional view of an extrusion die and quenching bath during the extrusion of a polymeric product and an apparatus for directing gas flow towards the extrusion die.

FIG. 3 is a map of a sheet formed by an extrusion process, showing the location of defects caused by die drips.

FIG. 4 is a graph comparing the number of defects formed by die drips in various segments of the sheet that is mapped in FIG. 3.

### DETAILED DESCRIPTION OF THE INVENTION

The following definitions apply to the terms as used throughout this specification, unless otherwise limited in specific instances.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B”. Exclusive “or” is designated herein by terms such as “either A or B” and “one of A or B”, for example.

In addition, the ranges set forth herein include their endpoints unless expressly stated otherwise. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

All percentages, parts, ratios, and the like set forth herein are by weight, unless otherwise limited in specific instances.

When materials, methods, or machinery are described herein with the term “known to those of skill in the art”, or a synonymous word or phrase, the term signifies that materials, methods, and machinery that are conventional at the time of filing the present application are encompassed by this description. Also encompassed are materials, methods, and machinery that are not presently conventional, but that will have become recognized in the art as suitable for a similar purpose.

The terms “die drip” and “die drool” are synonymous and are used interchangeably herein.

Likewise, the terms “melt fracture pattern” and “surface roughness” are also synonymous and used interchangeably herein. The phenomenon described by these terms may alternatively be referred to in the art as “sharkskin” or “embossment”.

The term “gas flow rate” refers to a value that is measured or is intended to be measured at standard temperature and pressure.

The terms “finite amount” and “finite value”, as used herein, refer to an amount that is greater than zero.

Described herein is a method of reducing the incidence of defects caused by die drips on extruded polymeric products. Extrusion is a well-known method of forming shaped articles from polymer melts. For general information about polymers that are suitable for extrusion processing, and about extrusion processes and conditions, see the Modern Plastics Encyclopedia, McGraw Hill (New York, 1994), The Encyclopedia of Polymer Science and Engineering, Wiley Interscience (New York, 1989), or the Wiley Encyclopedia of Packaging Technology, 2d edition, A. L. Brody and K. S. Marsh, Eds., Wiley-lnterscience (Hoboken, 1997). It is anticipated that the methods of the invention will be useful in conjunction with conventional extrusion techniques.

Polymeric compositions that may be extruded under conditions that have generated or may generate die drips include, without limitation, compositions comprising polyolefins, such as polyethylene and polypropylene; polyamides, such as nylons; melt processable fluoropolymers; polyesters; copolymers of ethylene comprising one or more α,β-unsaturated carboxylic acids and ionomers of these copolymers; and polyacetals, such as polyvinyl butyral, for example.

Extrudable polymeric compositions comprising polyvinyl acetals are preferred for use in the methods described herein, and polyvinyl butyral is particularly preferred. Polyvinyl acetals may be formed by the reaction of a polyvinyl alcohol with one or more aldehydes. The polyvinyl alcohol starting materials preferably have an average degree of polymerization (DP or Mₙ) of from about 500 to about 3000, more preferably from about 1000 to about 2500.

Also preferably, the polyvinyl alcohol, which, in turn, may be synthesized by hydrolysis of a polyvinyl acetate, preferably has an average residual acetate group level of from about 8 to 30 mol %, more preferably from about 10 to 24 mol %, wherein 0 mol % of acetate groups corresponds to theoretically complete hydrolysis.

Preferably, the aldehyde with which the polyvinyl alcohol is reacted to form the polyvinyl acetal has from 4 to 6 carbon atoms. Specific examples of preferred aldehydes include, for example, n-butyl aldehyde, iso-butyl aldehyde, valeraldehyde, n-hexyl aldehyde, 2-ethylbutyl aldehyde and the like and mixtures thereof. More preferred aldehydes include, for example, n-butyl aldehyde, isobutyl aldehyde and n-hexyl aldehyde and mixtures thereof. As is noted above, n-butyl aldehyde is particularly preferred.

Preferably, the degree of acetalization of the polyvinyl acetal resin is 40 mol % or greater. More preferably, the degree of acetalization for the polyvinyl acetal resin is 50 mol % or greater. Here, the theoretical total number of hydroxyl groups in the polyvinyl alcohol includes the number of residual acetate ester groups. Thus, preferably at least about 40 or 50 mol % of the theoretical total number of hydroxyl groups are reacted with an aldehyde and form part of an acetal group.

When the extrudable polymeric composition comprises a polyvinyl butyral, it preferably has a weight average molecular weight (Mw) in the range of from about 30,000 to about 600,000 D, more preferably from about 45,000 to about 300,000 D, and still more preferably from about 200,000 to 300,000 D, as measured by size exclusion chromatography using low angle laser light scattering. Also preferably, the polyvinyl butyral comprises, on a weight basis, about 12 to about 23%, preferably about 18 to about 21%, more preferably about 15 to about 20% and still more preferably about 17 to about 20% of hydroxyl groups, again calculated as polyvinyl alcohol. This quantity is also known as the polymer's “hydroxyl number”.

In addition, a preferred polyvinyl butyral material may incorporate a finite amount up to about 10 wt %, preferably up to about 3 wt % of residual ester groups, calculated as polyvinyl ester. The esters are typically copolymerized vinyl acetate groups. The preferred poly(vinyl butyral) may also include a relatively small amount of acetal groups other than butyral, for example, 2-ethyl hexanal, as described in U.S. Pat. No. 5,137,954.

Polyvinyl acetal resins may be produced by aqueous or solvent acetalization. In a solvent process, and using polyvinyl butyral as a specific example, acetalization is carried out in the presence of sufficient solvent to dissolve the polyvinyl butyral formed and produce a homogeneous solution at the end of acetalization. The polyvinyl butyral is separated from solution by precipitation of solid particles with water, which are then washed and dried. Solvents used are lower aliphatic alcohols such as ethanol. In an aqueous process, acetalization is carried out by adding butyraldehyde to a water solution of polyvinyl alcohol at a temperature on the order of about 20° C. to about 100° C., in the presence of an acid catalyst, agitating the mixture to cause an intermediate polyvinyl butyral to precipitate in finely divided form and continuing the agitation while heating until the reaction mixture has proceeded to the desired end point, followed by neutralization of the catalyst, separation, stabilization and drying of the polyvinyl butyral resin.

The extrudable polymeric composition may include one or more additives, for example one or more plasticizers. Suitable plasticizers, plasticizer levels, and methods of incorporating plasticizers into polymeric compositions are described in the general references cited herein, such as the Modern Plastics Encyclopedia. Suitable levels of plasticizer in the extrudable polymeric composition depend on the polymer type, the physical properties of the neat polymer, and the desired properties of the extruded polymer product. The plasticizer levels in this section are expressed as parts per hundred (pph) by weight, based on the total weight of the extrudable polymeric composition.

Examples of preferred plasticizers include, but are not limited to, stearic acid, oleic acid, soybean oil, epoxidized soybean oil, corn oil, caster oil, linseed oil, epoxidized linseed oil, mineral oil, alkyl phosphate esters, Tween™ 20 plasticizers, Tween™ 40 plasticizers, Tween™ 60 plasticizers, Tween™ 80 plasticizers, Tween™ 85 plasticizers, sorbitan monolaurate, sorbitan monooleate, sorbitan monopalmitate, sorbitan trioleate, sorbitan monostearate, citrate esters, such as trimethyl citrate, triethyl citrate, (Citroflex™ 2 plasticizer, produced by Morflex, Inc. Greensboro, N.C.), tributyl citrate, (Citroflex™ 4 plasticizer, produced by Morflex, Inc., Greensboro, N.C.), trioctyl citrate, acetyltri-n-butyl citrate, (Citroflex™ A-4 plasticizer, produced by Morflex, Inc., Greensboro, N.C.), acetyltriethyl citrate, (Citroflex™ A-2 plasticizer, produced by Morflex, Inc., Greensboro, N.C.), acetyltri-n-hexyl citrate, (Citroflex™ A-6 plasticizer, produced by Morflex, Inc., Greensboro, N.C.), and butyryltri-n-hexyl citrate, (Citroflex™ B-6 plasticizer, produced by Morflex, Inc., Greensboro, N.C.), tartarate esters, such as dimethyl tartarate, diethyl tartarate, dibutyl tartarate, and dioctyl tartarate, poly(ethylene glycol), derivatives of poly(ethylene glycol), paraffin, monoacyl carbohydrates, such as 6-O-sterylglucopyranoside, glyceryl monostearate, Myvaplex™ 600 plasticizer, (concentrated glycerol monostearates), Nyvaplex™ plasticizer, (concentrated glycerol monostearate which is a 90% minimum distilled monoglyceride produced from hydrogenated soybean oil and which is composed primarily of stearic acid esters), Myvacet™ plasticizer, (distilled acetylated monoglycerides of modified fats),Myvacet™ 507 plasticizer, (48.5 to 51.5 percent acetylation), Myvacet™ 707 plasticizer, (66.5 to 69.5 percent acetylation), Myvacet™908 plasticizer, (minimum of 96 percent acetylation), Myverol™ plasticizer, (concentrated glyceryl monostearates), Acrawax™ plasticizer, N,N-ethylene bis-stearamide, N,N-ethylene bis-oleamide, dioctyl adipate, diisobutyl adipate, diethylene glycol dibenzoate, dipropylene glycol dibenzoate, polymeric plasticizers, such as poly(1,6-hexamethylene adipate), poly(ethylene adipate), Rucoflex™ plasticizer, and other compatible low molecular weight polymers and mixtures thereof.

When the extrudable polymeric composition comprises a polyvinyl acetal, it preferably also comprises a plasticizer. Suitable plasticizers for use in polyvinyl acetal compositions are described in U.S. Pat. Nos. 3,841,890; 4,144,217; 4,276,351; 4,335,036; 4,902,464; and 5,013,779, and in Intl. Patent. Appln. Publn. No. WO 96/28504, for example. Preferred plasticizers for polyvinyl acetal compositions include monobasic acid esters, polybasic acid esters, organic phosphates, organic phosphites, and the like and mixtures of two or more of such plasticizers. Specific examples of preferred monobasic esters include glycol esters prepared by the reaction of triethylene glycol with butyric acid, isobutyric acid, caproic acid, 2-ethylbutyric acid, heptanoic acid, n-octylic acid, 2-ethylhexylic acid, pelagonic acid (n-nonylic acid), decylic acid, and the like and mixtures thereof. Other useful monobasic acid esters may be prepared by reacting tetraethylene glycol or tripropylene glycol with the above mentioned organic acids. Preferred examples of the polybasic acid esters include those prepared from adipic acid, sebacic acid, azelaic acid, and the like and mixtures thereof, with a straight-chain or branched-chain alcohol having 4 to 8 carbon atoms. Preferred examples of the phosphate or phosphite plasticizers include tributoxyethyl phosphate, isodecylphenyl phosphate, triisopropyl phosphite and the like and mixtures thereof. More preferred plasticizers include monobasic esters such as triethylene glycol di-2-ethylbutyrate, triethylene glycol di-2-ethylhexoate, triethylene glycol dicaproate and triethylene glycol di-n-octoate, oligoethylene glycol di-2-ethylhexanoate, and dibasic acid esters such as dibutyl sebacate, dihexyl adipate, dioctyl adipate, mixtures of heptyl and nonyl adipates, dioctyl azelate and dibutylcarbitol adipate, polymeric plasticizers such as the oil-modified sebacid alkyds, and mixtures of phosphates and adipates, and adipates and alkyl benzyl phthalates. Particularly preferred plasticizers include diesters of polyethylene glycol such as triethylene glycol di(2-ethylhexanoate), tetraethylene glycol diheptanoate and triethylene glycol di(2-ethylbutyrate) and dihexyl adipate.

Preferably the plasticizer(s) in the polyvinyl acetal composition are present in an amount of from about 15 to about 60 or about 70 pph. More preferably the plasticizer(s) are present in an amount of from about 30 to about 55 or 65 pph.

Preferably, a single plasticizer is used in the extrudable polyvinyl acetal composition. More preferably, the plasticizer comprises or consists essentially of tetraethylene glycol diheptanoate or dibutyl sebacate. Still more preferably the plasticizer comprises or consists essentially of triethylene glycol di(2-ethylhexanoate).

Other additives suitable for use in the extrudable polymeric composition include adhesion control additives, which are intended to control the strength of the adhesive bond between a glass rigid layer and an extruded polymeric sheet. Suitable adhesion control additives include, without limitation, alkali metal or alkaline earth metal salts of organic and inorganic acids. Preferred adhesion control additives include, without limitation, alkali metal or alkaline earth metal salts of organic carboxylic acids having from 2 to 16 carbon atoms. More preferred adhesion control additives include, without limitation, magnesium or potassium salts of organic carboxylic acids having from 2 to 16 carbon atoms. Specific examples of suitable adhesion control additives include, for example, potassium acetate, potassium formate, potassium propanoate, potassium butanoate, potassium pentanoate, potassium hexanoate, potassium 2-ethylbutylate, potassium heptanoate, potassium octanoate, potassium 2-ethylhexanoate, magnesium acetate, magnesium formate, magnesium propanoate, magnesium butanoate, magnesium pentanoate, magnesium hexanoate, magnesium 2-ethylbutylate, magnesium heptanoate, magnesium octanoate, magnesium 2-ethylhexanoate, and the like and mixtures thereof. The adhesion control additive(s) may be present at a level in the range of about 0.001 to about 0.5 wt %, based on the total weight of the extrudable polymeric composition.

One or more silane coupling agents may be included in the extrudable polymeric composition, for example to improve the strength of the adhesive bond between a glass rigid layer and an extruded polymeric sheet. Specific examples of useful silane coupling agents include; gamma-chloropropylmethoxysilane, vinyltrichlorosilane, vinyl triethoxysilane, vinyltris(beta-methoxyethoxy) silane, gamma-methacryloxypropyl trimethoxysilane, beta-(3,4-epoxycyclohexyl) ethyltrimethoxysilane, gamma-glycidoxypropyl trimethoxysilane, vinyl-triacetoxysilane, gamma-mercaptopropyl trimethoxysilane, gamma-aminopropyltriethoxysilane, N-beta-(aminoethyl)-gamma-aminopropyl-trimethoxysilane, and the like and combinations thereof. Silane coupling agent(s) may be added in a finite amount up to about 5 wt % based on the total weight of the extrudable polymeric composition. Preferably, the silane coupling agents may be included in a finite amount up to about 1 wt %, up to about 0.5 wt %, or up to about 0.1 wt %.

One or more surface tension modifiers may also be included in the extrudable polymeric composition. Suitable surface tension modifiers include fluoropolymers, such as those available under the trade name Dynamar™ from Dyneon, LLC, of Oakdale, Minn.; fluorosurfactants, such as those available under the trademark Zonyl® from E.I. du Pont de Nemours & Co. of Wilmington, Del.; and silicone surfactants, including polyalkylene oxide modified polydimethylsiloxanes such as those available under the trade name Silwet™ or Coatasil™ from Momentive Performance Materials, Inc., of Wilton, Conn. (formerly GE Silicones). Polyalkylene oxide modified silicone oils and, in particular, polyalkylene oxide modified polydimethylsiloxanes are preferred as surface tension modifiers. Surface tension modifier(s) may be added in a finite amount up to about 5 wt % based on the total weight of the extrudable polymeric composition. Preferably, the silane coupling agents may be included in a finite amount up to about 1 wt %, up to about 0.5 wt %, up to about 0.1 wt %, up to about 0.05 wt %, or up to about 0.01 wt %.

The extrudable polymeric composition may also include an effective amount of one or more thermal stabilizers. Any known thermal stabilizer may find utility within the present invention. Preferred classes of thermal stabilizers include phenolic antioxidants, alkylated monophenols, alkylthiomethylphenols, hydroquinones, alkylated hydroquinones, tocopherols, hydroxylated thiodiphenyl ethers, alkylidenebisphenols, O-, N- and S-benzyl compounds, hydroxybenzylated malonates, aromatic hydroxybenzyl compounds, triazine compounds, aminic antioxidants, aryl amines, diaryl amines, polyaryl amines, acylaminophenols, oxamides, metal deactivators, phosphites, phosphonites, benzylphosphonates, ascorbic acid (vitamin C), compounds which destroy peroxide, hydroxylamines, nitrones, thiosynergists, benzofuranones, indolinones, and the like and mixtures thereof. When used, the thermal stabilizer(s) may be present in a finite amount up to about 10.0 wt %; more preferably, up to about 5.0 wt %; and still more preferably, up to about 1.0 wt %, based on the total weight of the extrudable polymeric composition.

The extrudable polymeric composition may further include an effective amount of one or more UV absorbers. Any known UV absorber may find utility within the present invention. Preferred classes of UV absorbers include benzotriazoles, hydroxybenzophenones, hydroxyphenyl triazines, esters of substituted and unsubstituted benzoic acids, and the like and mixtures thereof. When used, the UV absorber(s) may be present in a finite amount up to about 10.0 wt %; preferably, up to about 5.0 wt %; and more preferably up to about 1.0 wt %, based on the total weight of the extrudable polymericcomposition.

The extrudable polymeric composition may further include an effective amount of one or more hindered amine light stabilizers (HALS). Hindered amine light stabilizers include secondary and tertiary cyclic amines, which may be acetylated, N-hydrocarbyloxy substituted, hydroxy substituted, or otherwise substituted, and which further incorporate steric hindrance, generally derived from aliphatic substitution on the carbon atoms adjacent to the amine moiety. Essentially any hindered amine light stabilizer known within the art may find utility within the present invention. When used, the hindered amine light stabilizer(s) may be present in a finite amount up to about 10.0 wt %; preferably, up to about 5.0 wt %; and more preferably, up to about 1.0 wt %, based on the total weight of the extrudable polymeric composition.

The polymer composition may also include one or more additives such as, for example, UV stabilizers, colorants, processing aides, flow enhancing additives, lubricants, pigments, dyes, flame retardants, impact modifiers, nucleating agents to increase crystallinity, antiblocking agents such as silica, dispersants, surfactants such as sodium lauryl sulfate, sodium dioctyl sulfosuccinate, and alkylbenzenesulfonic acids, chelating agents, coupling agents, and the like. For further information on suitable additives and the levels at which they may be included in polymer compositions, see the Modern Plastics Encyclopedia, for example. It is anticipated that some polymer additives which have yet to be identified will also be of use in the present invention.

A particularly preferred extrudable polymeric composition comprises or consists essentially of a polyvinyl butyral having a hydroxyl number in the range of from about 12 to about 23 and a single plasticizer in the amount of from about 15 to about 60 pph. When the extruded polyvinyl butyral is intended for use as an interlayer in standard safety glass, the plasticizer is preferably triethyl glycol octanoate (3GO) and is preferably present at a level of from about 30 to about 40 pph. When the extruded polyvinyl butyral is intended for use in acoustic safety glass, the plasticizer is preferably present at a level of from about 40 to about 60 pph. When the extruded polyvinyl butyral is intended for use in safety glass for aircraft, or for hurricane safety, the plasticizer is preferably present at a level of from about 15 to about 35 pph.

Another particularly preferred extrudable polymeric composition comprises a polyvinyl butyral and one or more of a plasticizer, a silane coupling agent, and a surface tension modifier. More preferably, the polymeric composition comprises the polyvinyl butyral and at least one plasticizer, at least one silane coupling agent, and at least one surface tension modifier. Another more preferred polymeric composition includes the polyvinyl butyral, at least one plasticizer, and at least one surface tension modifier.

The methods of the invention are believed to be useful in a wide variety of extrusion processes, including those that are carried out under melt fracture conditions. Melt fracture is “[a] phenomenon sometimes encountered in extrusion, characterized by irregularities in the extrudate ranging from slight surface ripples to gross annular distortions in the entire cross section. For a given set of standard processing conditions and die geometry, there is a critical shear rate for a specific compound below which melt fracture does not occur and above which it will occur.” Whittington's Dictionary of Plastics, Carley, James F. and Graf, John, Eds., CRC Press (Boca Raton, 1993). Because melt fracture conditions may be obtained by subjecting an extrudate to higher shear rates, resins of lower melt index are more likely to attain melt fracture conditions. It also follows that, for a given polymer, melt fracture conditions are favored by lowering the melt temperature or increasing the die entry angle, for example.

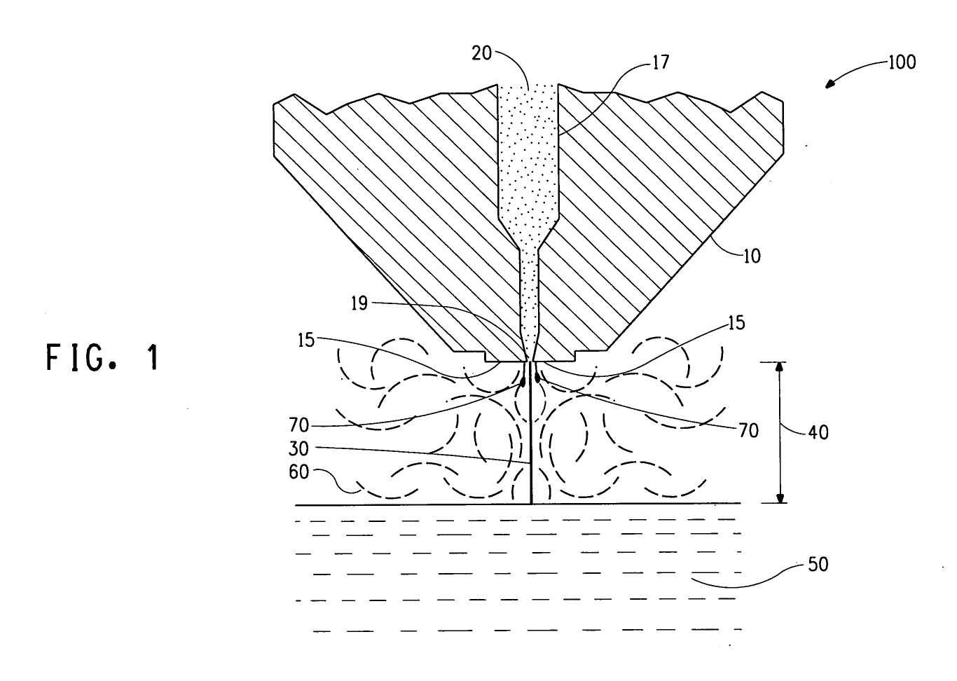

Referring now to the drawings, wherein like reference numerals designate corresponding structure throughout the views, and referring in particular to FIG. 1, a typical extrusion apparatus 100 includes an extrusion die 10. The die 10 includes die lips 15 and is equipped with a passage 17 ending in an aperture 19 through which a molten polymer composition 20 passes.

The extrusion die 10 may be suited to produce a polymeric extrudate having a cross section of any shape, such as, for example, square, circular, rectangular, or toroid. Preferred extrudates are round moldings, monofilaments, films, and sheets. Also preferred are dies 10 for batch processes, such as, for example, a die 10 for extruding a polymer around a wire. Particularly preferred is an extrusion die 10 suitable for forming a sheet. Some more preferred dies 10 are capable of forming sheets that are 70″ to 100″ (178 cm to 254 cm) in width and 25 to 90 mils (0.63 mm to 2.3 mm) in thickness. Particularly preferred dies 10 can form sheets that are about 100″ or 140″ (178 cm or 355 cm) in width and about 0.38 mils (1.0 mm) in thickness.

Upon exiting the aperture 19, the polymeric extrudate 30 is routed through an air gap 40 to a quenching bath 50. The quenching bath 50 is kept at a temperature that is lower than the temperature of extrudate 30 upon exiting the die 10.

When polyvinyl butyral is extruded under melt fracture conditions, the temperature of the molten polymeric extrudate 30 is preferably about 195° C. to about 225° C. Also preferably, when the polymeric composition is extruded under melt fracture conditions, the temperature of the quenching bath 50 is preferably sufficiently low so that the melt fracture pattern is preserved by rapid firming of the polymeric extrudate 30.

The air gap 40 is typically filled with fumes 60. These fumes include air currents, volatilized organic compounds, such as, for example, plasticizers, and water vapor. As is shown schematically in FIG. 1, the fumes 60 are believed to be turbulent.

Also shown in FIG.1 are die drips 70. It is believed that die drips 70 are formed by one or more mechanisms. For example, without wishing to be held to any theory, it is hypothesized that low molecular weight components of the polymer composition undergo partial phase separation from the molten polymer composition 20. This low molecular weight fraction migrates to the outer edges of the passage 17 because of the shear rate differential in the parabolic velocity profile of the molten polymer 20 in the passage 17. Upon exiting the extrusion die 10 through the aperture 19, the low molecular weight components migrate to the surface of the die lips 15 and, because of surface tension effects, become the deposit that is the precursor to die drips 70. When the force of gravity exceeds the surface wetting forces between the die lips 15 and the deposit, and the cohesive forces within the deposit, a die drip 70 is formed.

When the polymer composition includes polyvinyl butyral and the extrusion die 10 is a conventional sheet-forming die, die drips 70 form along the entire width of the die 10. When the build-up becomes excessive, the extrusion production lines 100 may temporarily produce non-salable product while the operators scrape the deposits from the die lips 15. In a typical production run, the die lips 15 must be cleaned once every 1 to 10 hours. Low molecular weight components of a polyvinyl butyral composition for extrusion include one or more plasticizers, in significant part, and may also include polyvinyl butyral species along with plasticizer hydrolysis products, or one or more of the additives in the polymer composition.

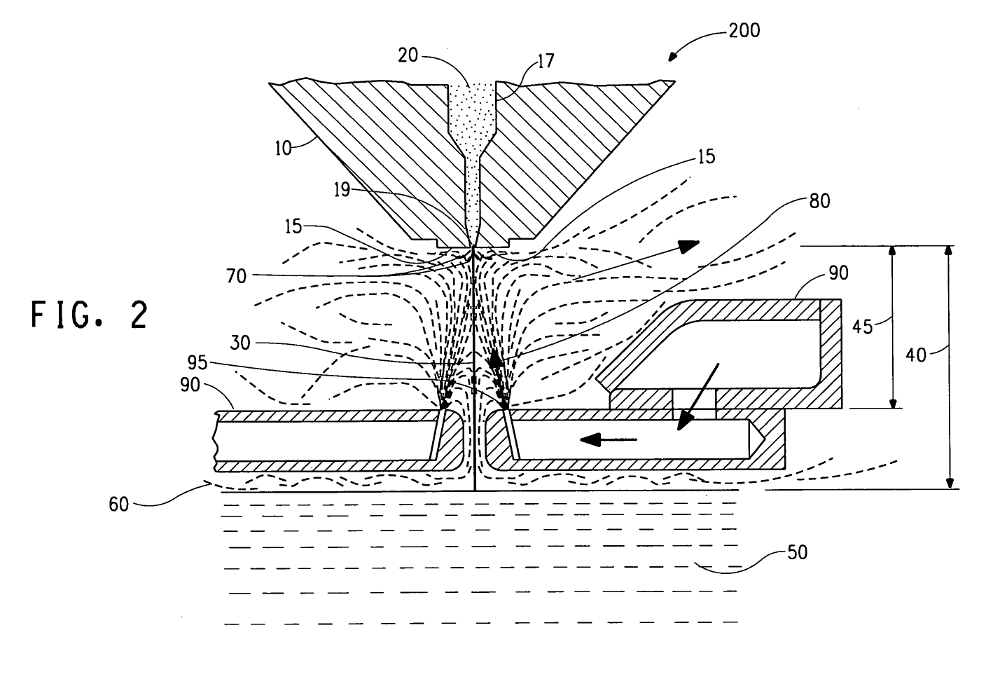

Referring now to FIG. 2, an extrusion apparatus 200 suitable for running a process according to the invention includes means for directing a flow of gas 80 towards the lips 15 of the extrusion die 10. Because of the gas flow 80 impinging on the die lips 15, die drips 70 are significantly reduced or substantially eliminated.

Again without wishing to be held to any theory, it is believed that die drips 70 are reduced by volatilization of at least a portion of the low molecular weight components into the gas flow 80. Thus, the rate of deposit formation is lower. In addition, it is hypothesized that a heated gas flow 80 favors surface wetting of the die lips 15 by lowering the viscosity of the deposits. Die drips 70 are reduced by improved wetting because a larger mass of deposit can be maintained on the die lips 70 before gravitational forces exceed the forces of surface tension and cohesion. Finally, any die drips 70 that may form in the course of a process according to the invention typically do not form surface defects by adhering to the extrudate 30, because they are generally deflected from the extrudate 30 by the velocity pressure of the air flow 80 that impinges upon the die lips 15. The velocity pressure also facilitates the spreading of the deposits and assists in forcing them away from the extrudate 30.

Any source of heat may be effective to reduce or eliminate die drips, because it is believed that this goal is accomplished by oxidation or volatilization of the deposits. Suitable heating sources thus include, without limitation, sources of radiant heat, conductive heat, or convective heat.

The flow of gas 80 is substantially parallel to one or more surfaces of the extrudate. Preferably, the direction of the flow of gas 80 does not deviate from the parallel by more than about 20°, 10°, 5°, 2°, 1°, or 0.1°.

The flow rate of the gas (at the point of impingement) 80 is suitably in the range of about 0.1 cfm (18.5 cm³/sec) to about 3.5 cfm (650 cm³/sec) per inch (per cm) of die width. Preferably, the flow rate ranges from about 0.2 cfm (37 cm³/sec) to about 2.25 cfm (418 cm³/sec) per inch (per cm) of die width, and more preferably from about 0.8 cfm (150 cm³/sec) to about 1.5 cfm (280 cm³/sec)per inch (per cm) of die width. The pressure drop across the entire system (including regulators, heaters, piping, flow switches, pressure equalizing orifices, and nozzle) is taken into account to achieve the proper gas flow rate 80. The temperature of the gas flow 80 is suitably in the range of about 50 to about 300° C. Preferably, the temperature ranges from about 80 to about 270° C., and more preferably from about 100 to about 180° C.

Suitable gases include any nonflammable process gas such as, for example, steam, air, nitrogen, or argon. Air is a preferred gas, for economical reasons, and “dry plant air” is more preferred. Without wishing to be held to any theory, it is believed that the water content of the gas flow 80 may have an effect on the physical or chemical properties of the polymeric extrudate 30; thus, variability in water content is preferably minimized.

Air entrainment with the nozzle flow will have to be considered. The narrower the nozzle opening, the greater the air entrainment will be. The effect of the air entrainment may negatively impact the flow rate and/or the temperature of the gas stream. Therefore, the air entrainment can be mitigated by maximizing the nozzle opening while still maintaining the necessary back pressure for an even flow and placing the nozzle opening as close to the desired point of impingement as possible.

Still referring to FIG. 2, in a preferred embodiment, gas flow 80 is provided by a manifold 90 that is positioned in the air gap 40. The die drip reduction apparatus comprises the manifold 90 and its supporting structure. The manifold 90 may be connected to or separate from the extrusion apparatus 200. Preferably, however, the design of the die drip reduction apparatus is “repeatable”, such that when the manifold 90 is removed from its working position, it is conveniently replaced in a substantially identical position. Repeatability is a desirable characteristic, because it minimizes variability in the products of the process of the invention. Such variability includes, for example, inconsistency in the surface roughness of the extrudate 30.

The apparatus can be either connected to the die or independent of it. Possible ways to move the apparatus to provide improved access to the die, for example for die cleaning and sheeting assessment, include incorporating four-bar linkages, linear rails, pivot systems, or the like into the supporting structure. These mechanisms may be powered by motors, manual manipulation of gears, air cylinders, and the like. The system can also be provided with ergonomic assisting devices such as gas springs, counterbalances, and the like. It is an advantage of the apparatus that it may be quickly and conveniently moved into and out of the air gap 40.

The gas flow 80 may be provided by any suitable means, such as air compressors and fans capable of supplying gas at the required pressure drop and flow rate for any given system, for example.

The design of the nozzle and air flow components of the apparatus will require consideration of several engineering and design factors, including the deflection of the nozzle across the span of the sheet width, the thermal expansion of the nozzle at elevated temperature, the heat transfer required to achieve the desired temperature at a given flow rate, safety considerations, the provision of sufficient back pressure in the nozzle so that the air is evenly distributed, the choice of insulation and the positioning of the heaters to ensure a uniform temperature across the width of the die aperture 19, insulation to ensure energy efficiency without intruding on the limited space around the die and whether the electronic features of the apparatus are suitable for use at the temperature of the gas flow 80.

In a preferred process for reducing the incidence of die drips in a polymer extrusion, the molten polymer composition 20 is extruded through a die 10 that is a sheet-forming or a film-forming die, preferably under melt fracture conditions. The polymeric extrudate 30 is thus a sheet or a film having a front surface and a back surface that are substantially parallel. A gas flow 80 is directed towards the die 10 along the front surface, the back surface, or both surfaces of the extrudate 30, and the gas flow 80 is substantially parallel to the front or back surface of the extrudate 30. The temperature of the gas flow 80 is from about 50° C. to about 300° C. when it impinges on the surface of the die 10.

Also described herein is a method of attaining a targeted surface roughness in an extruded polymer. In this method, a polymer composition is extruded to form an extrudate. The extrusion process may be conducted under melt fracture conditions. Again, and still referring to FIG. 2, a flow of gas 80 is directed towards the die 10, and the flow of gas 80 is substantially parallel to one or more surfaces of the extrudate 30. With the exceptions noted below, the suitable and preferred polymer compositions, apparatus, and process conditions are as set forth above with respect to the method of reducing the incidence of die drips in a polymeric extrusion process.

The surface roughness includes any pattern or asperities that have been imparted to the surface of the polymeric extrudate 30. Surface roughness is typically quantified by its amplitude and frequency. Certain preferred targets for surface roughness include an amplitude of 10 to 65 microns, preferably 20 to 55 microns, and a frequency of 0.8 to 4 cycles/mm, more preferably 1 to 2.5 cycles/mm, and still more preferably 0.8 to 1.6 cycles/mm. Zero is another preferred target amplitude.

The temperature or flow rate of the gas is selected to attain the targeted surface roughness. Without wishing to be held to any theory, the temperature of the gas flow is believed to affect the surface roughness by changing the die lip temperature, thereby increasing the shear rate. Therefore, in general, the surface roughness decreases as the temperature of the gas flow increases. The surface roughness may be decreased to zero, to a finite value, or to a negligible value by selecting an appropriate temperature of the gas flow or the die lips.

A temperature appropriate for a certain surface roughness may be selected by constructing a calibration curve, for example.

The following examples are provided to describe the invention in further detail. These examples, which set forth a preferred mode presently contemplated for carrying out the invention, are intended to illustrate and not to limit the invention.

### EXAMPLES

A sheet of polyvinyl butyral 100″ in width and 38 mils in thickness was produced under melt fracture conditions.

The extrusion line was further provided with an air blower 9″ wide, substantially as depicted in FIG. 2. The air blower was capable of providing air in the temperature range of 25 to 250° C. and at a flow rate of between 0 to 1.5 scfm (280 cm³/sec) per inch of width.

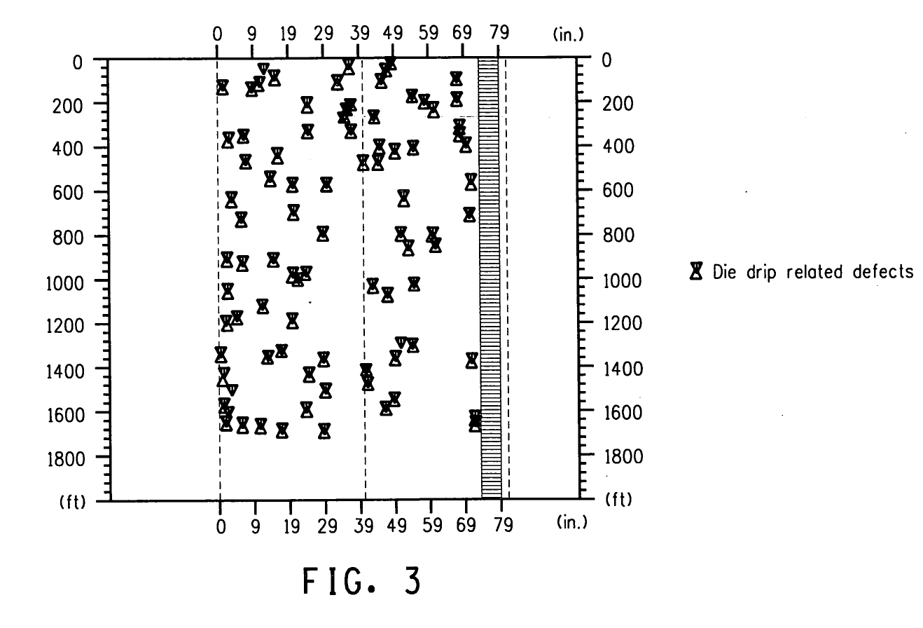

In a first experiment, the temperature of the air was 165° C. and its flow rate was approximately 14 scfm (0.40 m³/min). The air blower operated for 19.3 hours. FIG. 3 is a map of a portion of the sheet that was extruded in this experiment. The number and location of the die drips are shown by the symbols on the map. The x-axis is the width and the y-axis is the length of the roll. The data in the map were obtained by an in-line camera system, and the snapshot upon which the map is based was taken at 17.5 hours after the experiment began. The location of air blower is shown by the shaded strip between 70″ (1.8 m) and 79″ (2.0 m) on the horizontal axis, which in its entirety represents the full length of the extrusion die. The remainder of the die width was scraped 3.5 h before the collection of this data began.

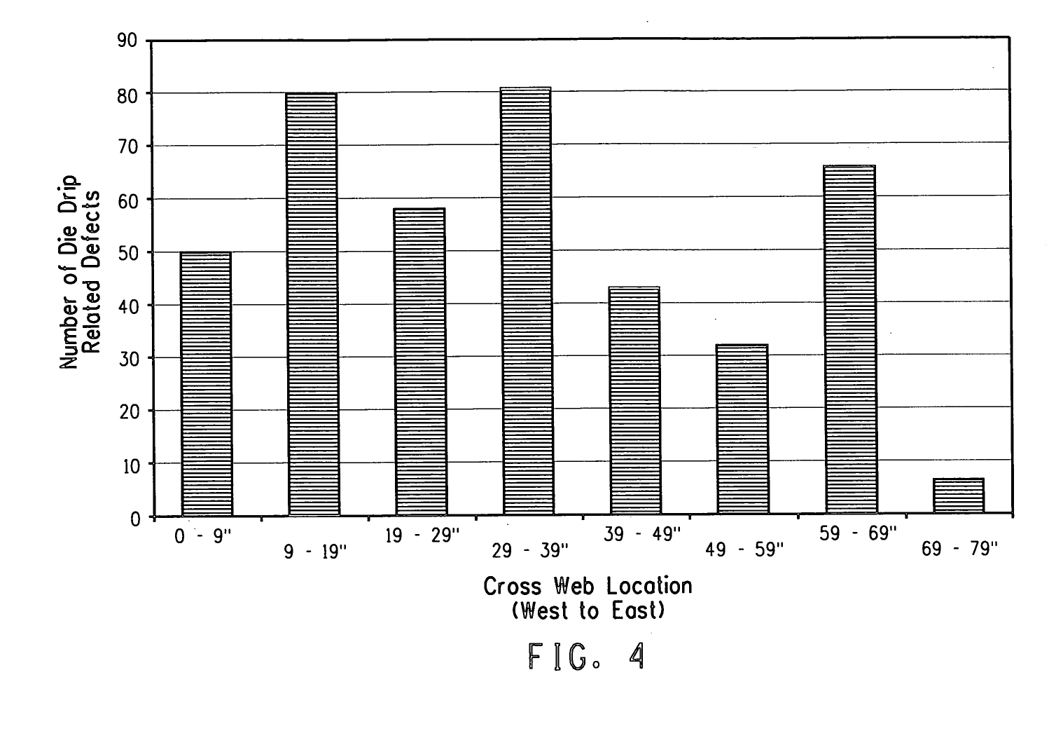

FIG. 4 is a graph showing the relative number of die drips occurring in the sheet in increments of approximately 9 inches (9″, 0.3 m) of the sheet width. Only 5 drips occurred in the segment towards which the air blower was directed (70″ to 79″, 1.8 m to 2.0 m), compared to an average of 61.3 drips in the other 9″ (0.3 m) segments of the extrusion die. These data are especially surprising because, in the 19.3 hours during which the extrusion process was run, the 9″ (0.3 m) area towards which the air blower was directed was not cleaned or scraped. The remainder of the length of the extrusion die, however, was cleaned or scraped 11 (eleven) times during the same period.

The data in FIGS. 3 and 4 demonstrate clearly that there was a highly significant reduction in die drips in the 9″ (0.3 m) strip of sheet that was extruded through the portion of the die towards which the air flow was directed.

In a second experiment, in which the extruded material and the extrusion conditions were substantially the same as in the first, the air temperature was varied between 150 and 225° C. The surface roughness of the extruded sheet was quantified, for the portion of the sheet that was extruded through the test area and for the portion that was extruded through the immediately adjacent area of the extrusion die, using a surface analyzer. The results of this experiment are set forth in Table 1, below.

TABLE 1
Surface Roughness as a Function of Temperature.

| Rz, microns | Frequency, cycles/mm | Air temperature, C° |
|---|---|---|
| 49.5 | 1.17 | 150 |
| 45.3 | 1.28 | 170 |
| 35.8 | 1.53 | 190 |
| 22 | 1.65 | 225 |

These data demonstrate that, as the temperature of the air directed at the die lips is increased, the amplitude (Rz) of the melt fracture pattern is decreased and the frequency of the roughness increases. Each of these effects produces a smoother pattern. The die drip reduction device consistently created sheeting with a lower frequency when compared to sheeting produced under similar conditions but without air impingement on the die lips. When further processed, as by lamination to one or more glass plates, for example, polyvinyl butyral sheeting whose surface pattern has a lower frequency allows air to escape from the laminate more efficiently. Moreover, at every temperature tested, the roughness average in the region under air flow was higher than that of the control region. Thus, these data demonstrate that the roughness of the extrudate is increased by decreasing the temperature of the impinging gas flow.

In a third experiment, the polymer composition included Coatasil™ L-7604 at a level of 0.05% and Silquest™ A-187 at a level of 0.005% in the plasticized polyvinyl butyral. The extrusion conditions were substantially the same as in the first and second experiments, and an air nozzle was placed across the full width of the extrusion die on both sides. The temperature of the air flowing through the nozzles was set at 50° C., to achieve a rougher melt fracture pattern. The air flow rate was approximately 0.8 scfm (150 cm³/sec) per inch (per 2.54 cm) of die width. In this experiment, the time between die cleanings was extended from 3 hours (without using the air blower) to greater than 100 hours (using the air blower).

While certain of the preferred embodiments of the present invention have been described and specifically exemplified above, it is not intended that the invention be limited to such embodiments. It is to be understood, moreover, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A process for reducing the incidence of die drips in a polymeric extrusion, said process comprising the steps of:
a) extruding a molten polymer composition through a die to produce an extrudate; and
b) directing a flow of gas towards the die along a surface of the extrudate, wherein the gas flow is substantially parallel to the surface of the extrudate, and wherein the temperature of the gas is from about 50° C. to about 300° C. when it impinges on the surface of the die.

2. The process of claim 1, wherein the molten polymer composition is extruded under melt fracture conditions.

3. The process of claim 1, wherein the polymer composition comprises polyvinyl butyral.

4. The process of claim 3, wherein the molten polymer composition is extruded under melt fracture conditions.

5. The process of claim 1, wherein the polymer composition further comprises one or more of a plasticizer, a silane coupling agent, or a surface tension modifier.

6. The process of claim 1, wherein the gas is air.

7. The process of claim 1, wherein the temperature of the gas is from about 80° C. to about 270° C. when it impinges on the surface of the die.

8. The process of claim 1, wherein the temperature of the gas is from about 100° C. to about 180° C. when it impinges on the surface of the die.

9. The process of claim 1, wherein the extrudate is a monofilament.

10. The process of claim 1, wherein the extrudate is a sheet or a film having two surfaces, and wherein the gas flow is substantially parallel to one or both surfaces of the extrudate.

11. A process for reducing the incidence of die drips in a polymer extrusion, said process comprising the steps of:
a) extruding a molten polymer composition through a die to produce a molten extrudate, wherein the die is a sheet-forming or film-forming die, and wherein the molten extrudate has a front surface and a back surface, and the front and back surfaces are substantially parallel; and
b) directing a flow of gas towards the die along the front surface, the back surface, or both surfaces of the molten extrudate, wherein the gas flow is substantially parallel to the front surface, the back surface, or both surfaces of the molten extrudate, and wherein the temperature of the gas is from about 50° C. to about 300° C. when it impinges on the surface of the die.

12. The process of claim 11, wherein the molten polymer composition is extruded under melt fracture conditions.

13. The process of claim 11, wherein the polymer composition comprises polyvinyl butyral.

14. The process of claim 13, wherein the molten polymer composition is extruded under melt fracture conditions.

15. The process of claim 11, wherein the polymer composition further comprises one or more of a plasticizer, a silane coupling agent, or a surface tension modifier.

16. The process of claim 11, wherein the gas is air.

17. The process of claim 11, wherein the temperature of the gas is from about 80° C. to about 270° C. when it impinges on the surface of the die.

18. The process of claim 11, wherein the temperature of the gas is from about 100° C. to about 180° C. when it impinges on the surface of the die.

19. A process for attaining a targeted surface roughness in an extruded polymer, comprising the steps of:
a) extruding a molten polymer composition through a die under melt fracture conditions to produce an extrudate;
b) directing a flow of gas towards the die along a surface of the extrudate, wherein the gas flow is substantially parallel to the surface of the extrudate; and
c) selecting the temperature of the gas or the gas flow rate to attain the targeted surface roughness.

20. The process of claim 19, wherein the targeted surface roughness is an amplitude of 10 to 65 microns and a frequency of 0.8 to 4 cycles/mm.

21. The process of claim 19, wherein the polymer composition comprises polyvinyl butyral.

22. The process of claim 19, wherein the gas is air.

23. The process of claim 19, wherein the temperature of the gas is from about 50° C. to about 300° C. when it impinges on the surface of the die.

24. The process of claim 19, wherein the targeted surface roughness is zero, a finite value, or a negligible value.

25. The process of claim 19, wherein the extrudate is a monofilament.

26. The process of claim 19, wherein the extrudate is a sheet or a film, and wherein the gas flow is directed along one surface or both surfaces of the film or the sheet.

27. An apparatus for reducing the incidence of die drips in a polymer extrusion process, said apparatus comprising a gas flow manifold that is reversibly connected to a support structure, wherein the gas flow manifold is removably and repeatably positioned in an air gap of a polymer extrusion apparatus.

28. The apparatus of claim 27, wherein the support structure comprises one or more of a four-bar linkage, a linear rail, or a pivot system.

29. The apparatus of claim 28, wherein the support structure is powered by one or more motors, by manual manipulation of gears, by air cylinders, or by a combination of two or more of the motor, the gears, or the air cylinder.

30. The apparatus of claim 27, further comprising one or more ergonomic assisting devices.

31. The apparatus of claim 30, wherein the one or more ergonomic assisting devices comprise a gas spring or a counterbalance.
